(19) United States
(12) Patent Application Publication
(10) Pub. No.: US 2026/0273992 A1
(43) Pub. Date: Sep. 17, 2026

(54) DECORATIVE PUMPKIN APPLIQUE

(71) Applicant: Jennifer Smith, Ontario, NY (US)

(72) Inventor: Jennifer Smith, Ontario, NY (US)

(21) Appl. No.: 19/554,870

(22) Filed: Mar. 3, 2026

Related U.S. Application Data
(60) Provisional application No. 63/767,170, filed on Mar. 5, 2025.

(51) Int. Cl. B44C 1/10

(52) U.S. Cl. CPC B44C 1/105

(57) ABSTRACT

A decorative applique for a pumpkin includes a first layer and a second layer configured to be detachable from the first layer. The first layer is constructed of a stretchable translucent material. The first layer has a first layer first surface having an area wherein the stretchable translucent material is configured to be markable by marking material. The first layer has a first layer second surface having an adhesive thereon. The second layer has a second layer first surface and a second layer second surface. The second layer first surface is configured to be removable from the adhesive on the first layer second surface.

### PRIORITY INFORMATION

This application claims priority from U.S. Provisional Patent Application, Ser. No. 63/767,170, filed on Mar. 5, 2025. The entire content of U.S. Provisional Patent Application, Ser. No. 63/767,170, filed on Mar. 5, 2025, is hereby incorporated by reference.

This application claims priority from U.S. Provisional Patent Application, Ser. No. 63/888,790, filed on Sep. 26, 2025. The entire content of U.S. Provisional Patent Application, Ser. No. 63/888,790, filed on Sep. 26, 2025, is hereby incorporated by reference.

### BACKGROUND

Conventionally, decorating pumpkins at Halloween, includes the carving of images into the pumpkin so that when a light source is placed within the pumpkin, the image is revealed by the illumination. The detail of the image is limited by the carving tools and skills of the decorator.

In most cases, small children are the driving force behind decorating pumpkins at Halloween.

However, most small children do not directly participate in the carving due to the danger associated with handling a sharp carving knife. Thus, small children do not receive the full satisfaction of decorating a pumpkin because usually an older person will carve the pumpkin for a small child to render the image desired by the child.

Thus, it is desirable to provide a system that allows a small child to fully participate in the decorating of the pumpkin at Halloween.

Moreover, it is desirable to provide a system that allows a small child to avoid using a sharp carving knife in the decorating of the pumpkin at Halloween.

Additionally, it is desirable to provide a system that allows a small child to fully participate in the decorating of the pumpkin at Halloween without requiring the small child to use a sharp carving knife.

### BRIEF DESCRIPTION OF THE DRAWINGS

The drawings are only for purposes of illustrating various embodiments and are not to be construed as limiting, wherein:

FIG. 1 illustrates a decorative pumpkin applique;

FIG. 2 illustrates a first surface of the application member of the decorative pumpkin applique of FIG. 1;

FIG. 3 illustrates a first surface of a stretchable image member of the decorative pumpkin applique of FIG. 1;

FIG. 4 illustrates another embodiment of a decorative pumpkin applique;

FIG. 5 illustrates the first surface of the application member of the decorative pumpkin applique of FIG. 4;

FIG. 6 illustrates the protective member of the decorative pumpkin applique of FIG. 4;

FIG. 7 illustrates another embodiment of a decorative pumpkin applique;

FIG. 8 illustrates an outline marking member of the embodiment of the decorative pumpkin applique of FIG. 7;

FIG. 9 illustrates the transferable marking material of the transferable marking material layer of FIG. 7; and

FIG. 10 illustrates another embodiment of a decorative pumpkin applique.

### DETAILED DESCRIPTION OF THE DRAWINGS

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts may be properly illustrated

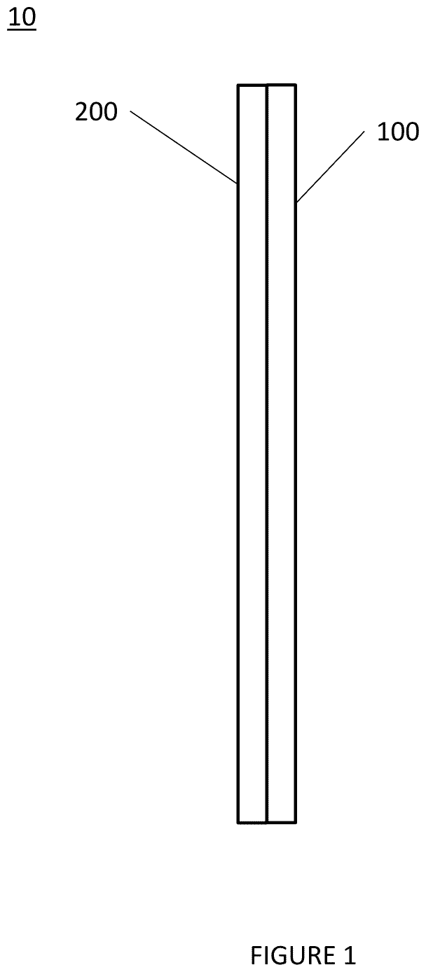

FIG. 1 illustrates a decorative pumpkin applique. As illustrated in FIG. 1, the decorative pumpkin applique 10 includes an application member 100 and a stretchable image member 200. The application member 100 may be stretchable, flexible, and breathable. A user adds a unique image to the stretchable image member 200 or colors a predetermined image on the stretchable image member 200. The image is created on transparent or translucent markable material such that when a light source is placed behind the stretchable image member 200, the image is rendered by the illumination. In this embodiment, the application member 100 and the stretchable image member 200 are distinct layers of material which are attached or fused together.

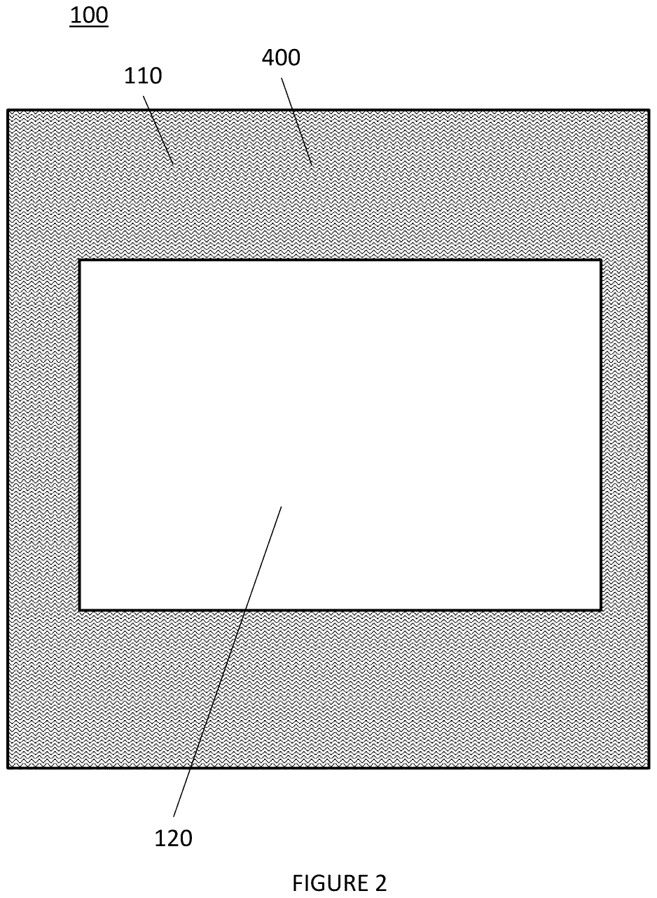

FIG. 2 illustrates a first surface of an application member of one embodiment of a decorative pumpkin applique. As illustrated in FIG. 2, the application member 100 includes an outer surrounding area 110 that surrounds a stretchable transparent/translucent area 120. The application member 100 may be stretchable, flexible, and breathable. The application member 100 has a second surface which does not engage the surface of a pumpkin, and the first surface which does engage the surface of a pumpkin.

The outer surrounding area 110 of the inner surface of the application member 100 includes an adhesive 400, thereon, for applying the decorative pumpkin applique to a pumpkin. The stretchable transparent/translucent area 120 is configured to allow an image to be visible by illumination passing therethrough.

The adhesive 400 is an acrylic pressure adhesive. An example of an acrylic pressure adhesive is 3M™ High Performance Acrylic Adhesive 200MP.

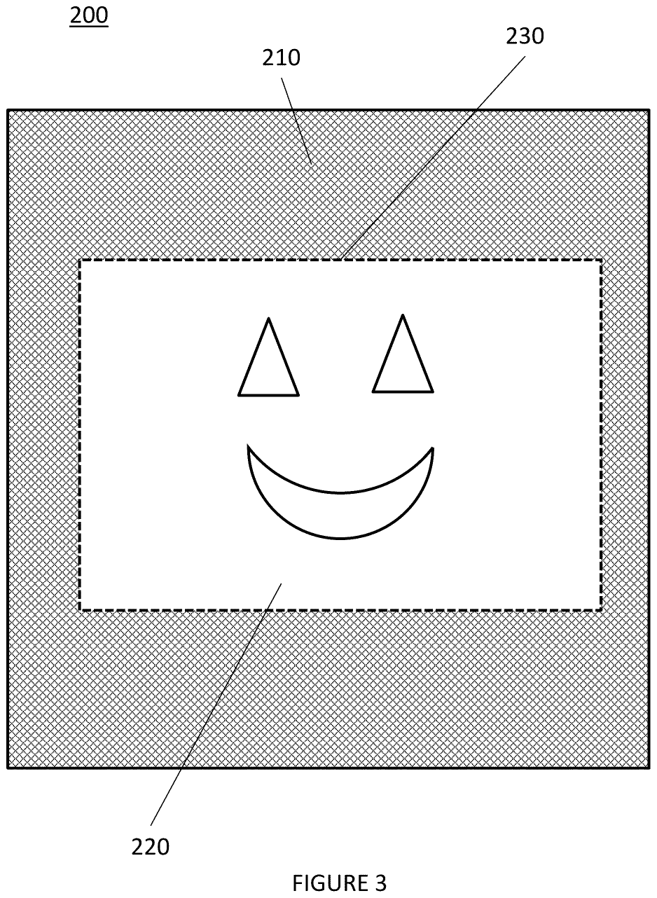

FIG. 3 illustrates a first surface of a stretchable image member of the embodiment of the decorative pumpkin applique of FIG. 2. As illustrated in FIG. 3, the stretchable image member 200 includes a stretchable transparent/translucent marking member 220 surrounded by a removable adhesive protective member 210, which is configured to cover (match the dimensions of) the area of the adhesive 400 of FIG. 2. The stretchable image member 200 has a second surface which does not engage the surface of a pumpkin.

The removable adhesive protective member 210 includes an acrylic pressure adhesive. An example of an acrylic pressure adhesive is 3M™ High Performance Acrylic Adhesive 200MP.

The removable adhesive protective member 210 includes a coating on a surface of the removable adhesive protective member 210 that engages the adhesive 400 of FIG. 2. The coating allows the removable adhesive protective member 210 to detach easily from the adhesive 400 of FIG. 2 without removing the adhesive 400. The removable adhesive protective member 210 may be configured to be detached from the stretchable transparent/translucent marking member 220 by perforations 230 surrounding the stretchable transparent/translucent marking member 220, as illustrated.

Although described above as two layers, the stretchable transparent/translucent marking member 220 may be fused into or to the application member 100. In this alternative embodiment, the stretchable transparent/translucent marking member 220 may be on the surface of the application member 100, which is away from the surface of the pumpkin when the decorative pumpkin applique is applied to the surface of the pumpkin, or the stretchable transparent/translucent marking member 220 may be on the surface of the application member 100, which is adjacent to the surface of the pumpkin when the decorative pumpkin applique is applied to the surface of the pumpkin.

Alternatively, the removable adhesive protective member 210 may be precut so that the removable adhesive protective member 210 is not connected to the stretchable transparent/translucent marking member 220. The precut embodiment of the removable adhesive protective member 210 would be used when the stretchable transparent/translucent marking member 220 is fused into or to the application member 100.

The stretchable transparent/translucent marking member 220 includes stretchable marking material 235, such as a stretchable ink, to form an image. An example of a stretchable ink is sold by Union Process, as a rubber ink Series 800. The stretchable marking material 235 enables the maintaining of the image when the stretchable transparent/translucent marking member 220 is stretched as it is being applied to a pumpkin's surface.

The stretchable transparent/translucent marking member 220 is constructed of a material that is transparent or translucent and can receive and retain marking material so as to render an image thereon. The user can create a unique image or color a predetermined (pre-existing) image on the stretchable transparent/translucent marking member 220. This image is illuminated by a light source in the pumpkin when the decorative pumpkin applique is applied to the pumpkin.

The stretchable transparent/translucent marking member 220 is configured to match the dimensions of the stretchable transparent/translucent area 120 of the application member 100 of FIG. 2 such that when the application member 100 of FIG. 2 and the stretchable image member 200 of FIG. 3 are attached together (fused, bonded, or glued together), the stretchable transparent/translucent area 120 of the application member 100 of FIG. 2 overlays the stretchable transparent/translucent marking member 220 of FIG. 3.

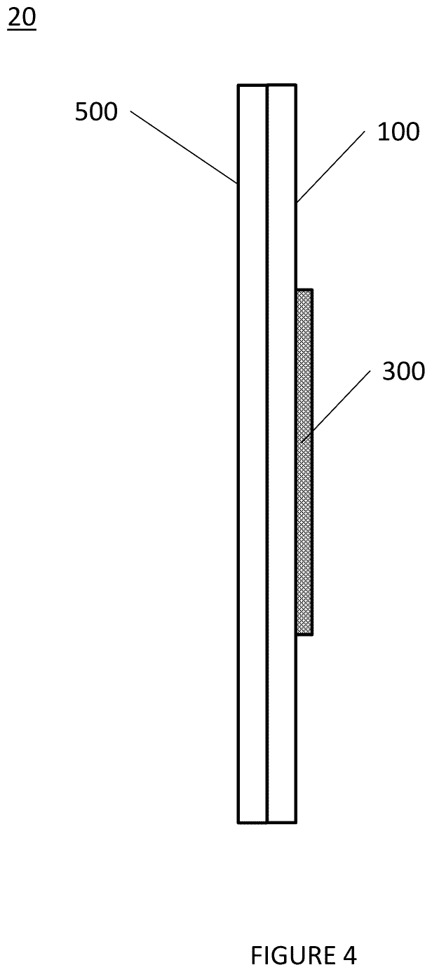

FIG. 4 illustrates another embodiment of a decorative pumpkin applique. As illustrated in FIG. 4, the decorative pumpkin applique 20 includes an application member 100, a removable protective member 500, and a stretchable image member 300.

The application member 100 may be stretchable, flexible, and breathable. The stretchable image member 300 is constructed of a material that is transparent or translucent and can receive and retain marking material so as to render an image thereon.

A user can add a unique image to the stretchable image member 300 or color a predetermined image on the stretchable image member 300. The image is created on transparent or translucent markable material such that when a light source is placed behind the stretchable image member 300, the image is rendered by the illumination.

Although the application member 100 and the stretchable image member 300 have been described as distinct layers of material, stretchable image member 300 may be attached or fused together on a second surface of the application member 100, wherein the second surface of the application member 100 does not engage a surface of the pumpkin.

Although the application member 100 and the stretchable image member 300 have been described as distinct layers of material, stretchable image member 300 may be attached or fused together on a first surface of the application member 100, wherein the first surface of the application member 100 engages a surface of the pumpkin.

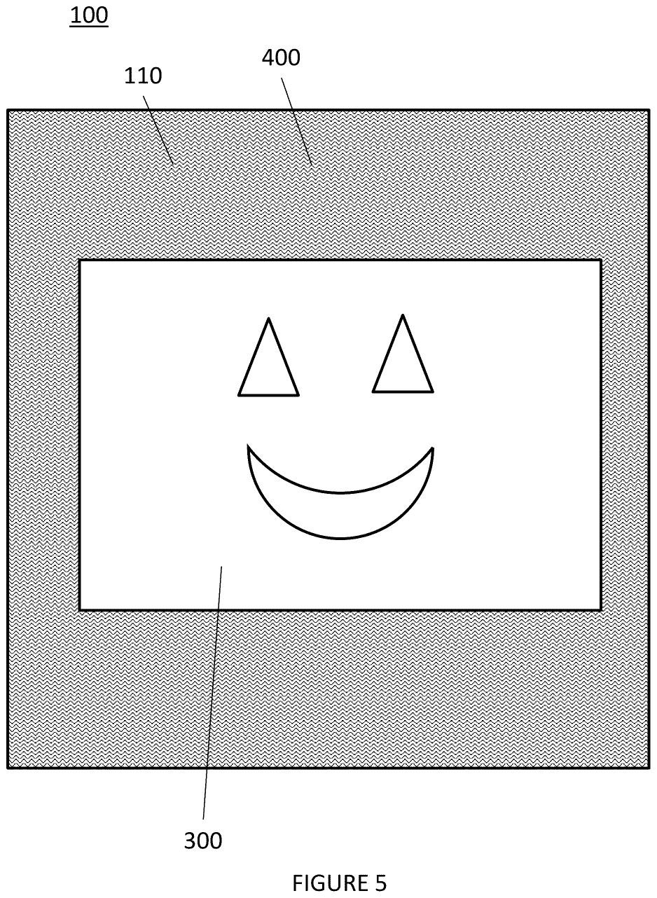

FIG. 5 illustrates the first surface of the application member 100 of the decorative pumpkin applique of FIG. 4. As illustrated in FIG. 5, the application member 100 includes an outer surrounding area 110 that surrounds stretchable image member 300. The outer surrounding area 110 includes an adhesive 400 for applying the decorative pumpkin applique to a pumpkin.

The stretchable image member 300 is constructed of a material that is transparent or translucent and can receive and retain marking material so as to render an image thereon. The user can create a unique image or color a predetermined (pre-existing) image on the transparent/translucent marking member 300. This image is illuminated by a light source in the pumpkin when the decorative pumpkin applique is applied to the pumpkin.

The stretchable image member 300 includes stretchable marking material, such as a stretchable ink, to form an image. An example of a stretchable ink is sold by Union Process, as a rubber ink Series 800. The stretchable marking material enables the maintaining of the image when the stretchable image member 300 is stretched as it is being applied to a pumpkin's surface.

The application member 100 and the stretchable image member 300 may be attached or fused together on the first surface of the application member 100 or attached or fused together on the second surface of the application member 100.

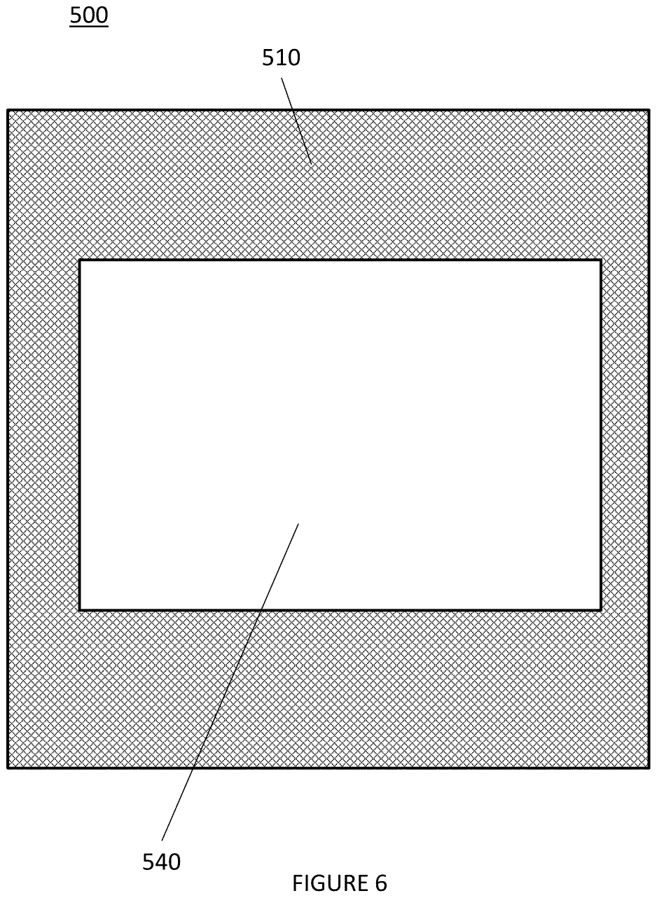

FIG. 6 illustrates a removable protective member of the embodiment of the decorative pumpkin applique of FIG. 4. As illustrated in FIG. 6, the removable protective member 500 includes an opening 540 surrounded by a removable adhesive protective member 510, which is configured to cover (match the dimensions of) the area of the adhesive 400 of FIG. 5.

The removable adhesive protective member 510 includes a coating on a surface of the removable adhesive protective member 510 that engages the adhesive 400 of FIG. 5. The coating allows the removable adhesive protective member 510 to detach easily from the adhesive 400 of FIG. 5 without removing the adhesive 400.

The removable adhesive protective member 510 is configured to be detached from the application member 100 of FIG. 5 by lifting the removable adhesive protective member 500 away from the application member 100 of FIG. 5.

The opening 540 is configured to match the dimensions of the transparent/translucent marking (image) member 300 of the application member 100 of FIG. 5 such that when the application member 100 of FIG. 5 and the removable protective member 500 of FIG. 6 are attached together, the removable adhesive protective member 510 of the removable protective member 500 of FIG. 6 overlays the adhesive 400 of FIG. 5.

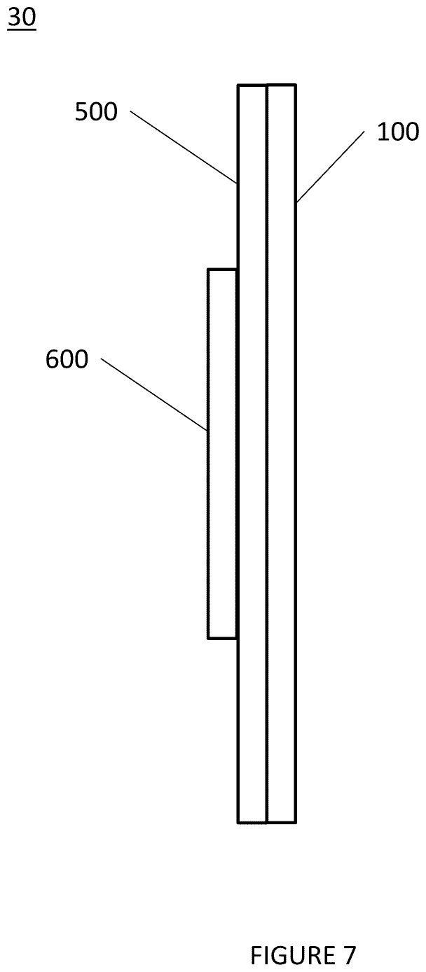

FIG. 7 illustrates another embodiment of a decorative pumpkin applique. As illustrated in FIG. 7, the decorative pumpkin applique 30 includes an application member 100 and a removable protective member 500. A user adds a unique image to the application member 100 or colors a predetermined image on the application member 100. The image is created on transparent or translucent material such that when a light source is placed behind the image created on the application member 100, the image is rendered by the illumination.

As noted above, application member 100 may include a stretchable image member (not shown) which is on a first surface of the application member 100 wherein the first surface of the application member 100 engages a surface of the pumpkin. Alternatively, application member 100 may include a stretchable image member (not shown) which is on a second surface of the application member 100 wherein the second surface of the application member 100 does not engage a surface of the pumpkin.

The decorative pumpkin applique 30 also includes an outline marking member 600 attached to removable protective member 500. The outline marking member 600 includes a transferable marking material configured to create, when the outline marking member 600 is pressed against a surface of a pumpkin, an outline of an area on a pumpkin to be removed by a craving knife or other means. The outline corresponds to the outer boundary of the imageable area of decorative pumpkin applique 30 such that when the area, marked by the transferable marking material, is removed, illumination from a light source within the pumpkin can render the created image on the imageable area of decorative pumpkin applique 30.

It is noted that the outline marking member 400 can be utilized with the removable protective member 500 of FIG. 6. In this alternative, the outline marking member 500 is attached to the removable adhesive protective member 510.

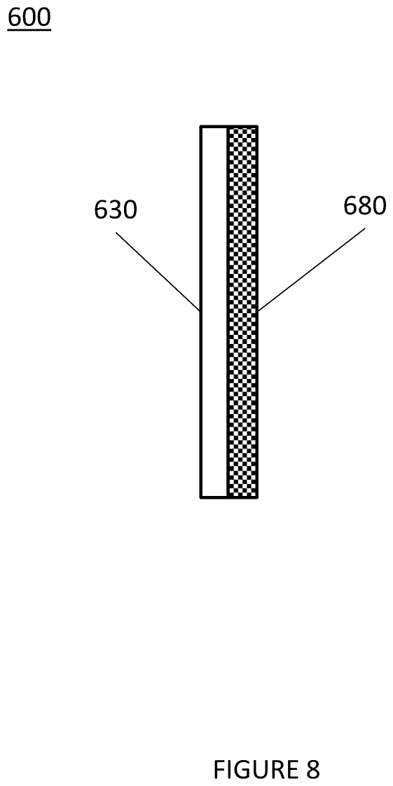

FIG. 8 illustrates an outline marking member of the embodiment of the decorative pumpkin applique of FIG. 7. As illustrated in FIG. 8, the outline marking member 600 includes a transferable marking material layer 680 and a removable protective layer 630. The transferable marking material layer 680 includes a transferable marking material configured to create, when the outline marking member 600 is pressed against a surface of a pumpkin, an outline of an area on a pumpkin to be removed by a craving knife or other means.

The removable protective layer 630 covers the transferable marking material layer 680 to protect the transferable marking material from being transferred to an undesired object. Upon removal of the removable protective layer 630, the transferable marking material of the transferable marking material layer 680 can be transferred to a surface upon application thereon.

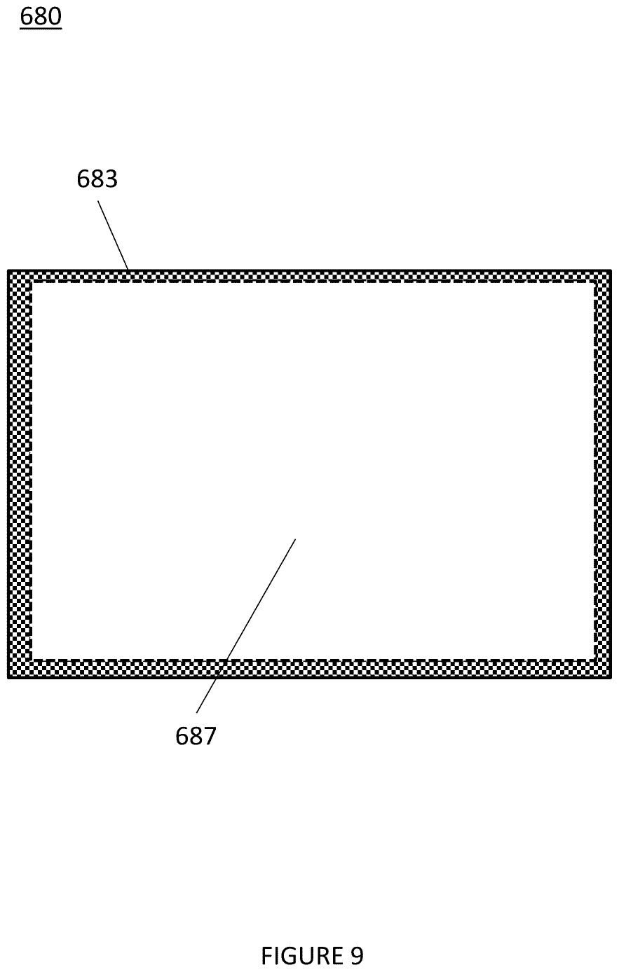

FIG. 9 illustrates the transferable marking material of the transferable marking material layer of FIG. 8. As illustrated in FIG. 9, the transferable marking material 683 is configured to border an image area of the decorative pumpkin applique to create an opening 687, which corresponds to an area on a pumpkin to be removed by a craving knife or other means.

The transferable marking material 683, when the transferable marking material 683 is applied to a surface of a pumpkin, an outline of an area on a pumpkin to be removed by a craving knife or other means. This enables the user to create the correct opening in the pumpkin that allows illumination from a light source within the pumpkin to properly illuminate the created image.

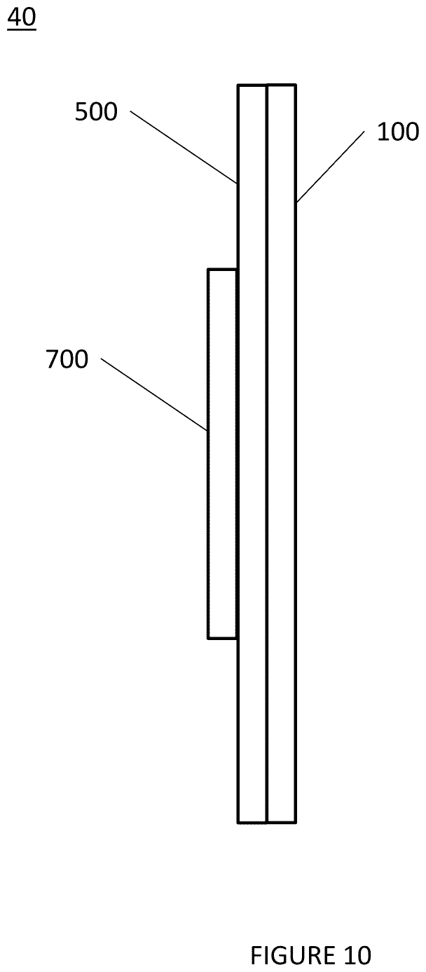

FIG. 10 illustrates another embodiment of a decorative pumpkin applique. As illustrated in FIG. 10, the decorative pumpkin applique 40 includes an application member 100 and a removable protective member 500. A user adds a unique image to the application member 100 or colors a predetermined image on the application member 100. The image is created on transparent or translucent material such that when a light source is placed behind the image created on the application member 100, the image is rendered by the illumination.

As noted above, application member 100 may include a stretchable image member (not shown) which is on a first surface of the application member 100 wherein the first surface of the application member 100 engages a surface of the pumpkin. Alternatively, application member 100 may include a stretchable image member (not shown) which is on a second surface of the application member 100 wherein the second surface of the application member 100 does not engage a surface of the pumpkin.

The decorative pumpkin applique 40 also includes a removable template member 700 attached to removable protective member 500. The removable template member 700 is a layer having an adhesive on one surface thereof such that the removable template member 700 can be easily detached from the removable protective member 500.

Alternatively, in a different embodiment, the removable template member 700 is a layer having an adhesive on one surface thereof such that the removable template member 700 can be easily detached from the application member 100.

It is further noted that the removable template member 700 and the removable protective member 500 can be an integral piece such that removing of the removable template member 700 also removes the removable protective member 500.

Upon detaching the removable template member 700 from the removable protective member 500 or the application member 100, a user can apply the removable template member 700 to a surface of a pumpkin, via the adhesive, to create a template for an area of the pumpkin that needs to be removed to enable rendering of the image is created on transparent or translucent material when a light source is placed in the pumpkin and the decorative pumpkin applique 40 has been properly applied on the pumpkin with respect to the area removed via the removable template member 700.

The removable template member 700 corresponds to the outer boundary of the imageable area of decorative pumpkin applique 40 such that when the area, marked by the transferable marking material, is removed, illumination from a light source within the pumpkin can render the created image on the imageable area of decorative pumpkin applique 40.

It is noted that the removable template member 700 can be utilized with the removable protective member 500 of FIG. 6. In this alternative, the outline marking member 500 is attached to the removable adhesive protective member 510.

As discussed above, the decorative pumpkin applique is constructed of a markable transparent/translucent material that enables an image to be created thereon and illuminated by a light source within the pumpkin.

The decorative pumpkin applique may include an outer transparent/translucent layer to protect the markable transparent/translucent material from the weather.

The decorative pumpkin applique also includes an adhesive that enables the decorative pumpkin applique to be attached to the surface of a pumpkin. The adhesive should be weather resistant.

The disclosed decorative pumpkin applique allows an adult to carve an opening in a pumpkin corresponding to the dimensions of the markable transparent/translucent material area while allowing a small child to decorate (create an image in) the markable transparent/translucent material area without exposing the small child to the dangers of a carving knife.

In one embodiment, the disclosed decorative pumpkin applique is of a two layered construction, wherein a first layer is constructed of a weather resistant stretchable transparent/translucent layer, and a second layer includes a markable stretchable transparent/translucent area surrounded by a removable adhesive protection layer. The removable adhesive protection layer is removed from the decorative pumpkin applique when the decorative pumpkin applique is ready to be applied to the surface of the pumpkin.

In another embodiment, the disclosed decorative pumpkin applique is of a two layered construction, wherein a first layer is constructed of a weather resistant stretchable transparent/translucent layer having a (central) markable stretchable transparent/translucent area, and a second layer is a removable adhesive protection layer. The removable adhesive protection layer is removed from the decorative pumpkin applique when the decorative pumpkin applique is ready to be applied to the surface of the pumpkin.

Additionally, the disclosed decorative pumpkin applique may include an outline marking layer to create an area on a pumpkin to be removed by a craving knife or other means.

In the embodiments described above, the stretchable translucent layer and/or weather resistant stretchable transparent/translucent layer may be constructed of latex, natural latex, thermoplastic rubber, rubber, or other forms of rubber.

A decorative applique for a pumpkin includes a first layer; and a second layer configured to be detachable from the first layer; the first layer being constructed of a stretchable translucent material; the first layer having a first layer first surface having an area wherein the stretchable translucent material is configured to be markable by marking material; the first layer having a first layer second surface having an adhesive thereon; the second layer having a second layer first surface and a second layer second surface, the second layer first surface being configured to be removable from the adhesive on the first layer second surface.

The first layer may be constructed of a weather resistant stretchable translucent material.

The adhesive may be weather resistant.

The adhesive may be an acrylic pressure adhesive.

The decorative applique may include an outline marking member configured to be attached to the second layer second surface; the outline marking member including a transferable marking material layer and a removable protective layer.

The transferable marking material layer may be configured to imprint an outline on a pumpkin corresponding to an area of the pumpkin to be removed.

The decorative applique may include a removable template member configured to be attached the second layer second surface; the removable template member having an adhesive on one surface thereof such that the removable template member can be easily detached from the second layer second surface.

The removable template member may be configured to provide a stickable template for a pumpkin corresponding to an area of the pumpkin to be removed.

The first layer may be transparent.

A decorative applique for a pumpkin includes a first layer having a first layer first surface and a first layer second surface; a second layer configured to be detachable from the first layer second surface; and a third layer attached to the first layer first surface; the first layer being constructed of a stretchable translucent material; the third layer being constructed of a stretchable translucent material; the third layer being configured to be markable by marking material; the first layer second surface having an adhesive thereon; the second layer having a second layer first surface and a second layer second surface, the second layer first surface being configured to be removable from the adhesive on the first layer second surface.

The first layer and the third layer may be constructed of a weather resistant stretchable translucent material.

The adhesive may be weather resistant.

The adhesive may be an acrylic pressure adhesive.

The decorative applique may include an outline marking member configured to be attached to the second layer second surface; the outline marking member including a transferable marking material layer and a removable protective layer.

The transferable marking material layer may be configured to imprint an outline on a pumpkin corresponding to an area of the pumpkin to be removed.

The decorative applique may include a removable template member configured to be attached the second layer second surface; the removable template member having an adhesive on one surface thereof such that the removable template member can be easily detached from the second layer second surface.

The first layer and third layer may be transparent.

In the various embodiments above, the portion of the layers or members that surround the imageable area of decorative pumpkin applique may be colored, preferably a color to match the pumpkin, such that the user can easily visualize the image to be created on the pumpkin.

It will be appreciated that variations of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the description above.

What is claimed is:

1. A decorative applique for a pumpkin, comprising:
a first layer; and
a second layer configured to be detachable from said first layer;
said first layer being constructed of a stretchable translucent material;
said first layer having a first layer first surface having an area wherein said stretchable translucent material is configured to be markable by marking material;
said first layer having a first layer second surface having an adhesive thereon;
said second layer having a second layer first surface and a second layer second surface, said second layer first surface being configured to be removable from said adhesive on said first layer second surface.

2. The decorative applique, as claimed in claim 1, wherein said first layer is constructed of a weather resistant stretchable translucent material.

3. The decorative applique, as claimed in claim 1, wherein said adhesive is weather resistant.

4. The decorative applique, as claimed in claim 2, wherein said adhesive is weather resistant.

5. The decorative applique, as claimed in claim 1, wherein said adhesive is an acrylic pressure adhesive.

6. The decorative applique, as claimed in claim 2, wherein said adhesive is an acrylic pressure adhesive.

7. The decorative applique, as claimed in claim 3, wherein said adhesive is an acrylic pressure adhesive.

8. The decorative applique, as claimed in claim 1, further comprising:
an outline marking member configured to be attached to said second layer second surface;
said outline marking member including a transferable marking material layer and a removable protective layer.

9. The decorative applique, as claimed in claim 8, wherein said transferable marking material layer is configured to imprint an outline on a pumpkin corresponding to an area of the pumpkin to be removed.

10. The decorative applique, as claimed in claim 1, further comprising:
a removable template member configured to be attached said second layer second surface;
said removable template member having an adhesive on one surface thereof such that said removable template member can be easily detached from said second layer second surface.

11. The decorative applique, as claimed in claim 10, wherein said removable template member is configured to provide a stickable template for a pumpkin corresponding to an area of the pumpkin to be removed.

12. The decorative applique, as claimed in claim 1, said first layer is transparent.

13. A decorative applique for a pumpkin, comprising:
a first layer having a first layer first surface and a first layer second surface;
a second layer configured to be detachable from said first layer second surface; and
a third layer attached to said first layer first surface;
said first layer being constructed of a stretchable translucent material;
said third layer being constructed of a stretchable translucent material;
said third layer being configured to be markable by marking material;
said first layer second surface having an adhesive thereon;
said second layer having a second layer first surface and a second layer second surface, said second layer first surface being configured to be removable from said adhesive on said first layer second surface.

14. The decorative applique, as claimed in claim 13, wherein said first layer and said third layer are constructed of a weather resistant stretchable translucent material.

15. The decorative applique, as claimed in claim 13, wherein said adhesive is weather resistant.

16. The decorative applique, as claimed in claim 13, wherein said adhesive is an acrylic pressure adhesive.

17. The decorative applique, as claimed in claim 13, further comprising:
an outline marking member configured to be attached to said second layer second surface;
said outline marking member including a transferable marking material layer and a removable protective layer.

18. The decorative applique, as claimed in claim 17, wherein said transferable marking material layer is configured to imprint an outline on a pumpkin corresponding to an area of the pumpkin to be removed.

19. The decorative applique, as claimed in claim 13, further comprising:
a removable template member configured to be attached said second layer second surface;
said removable template member having an adhesive on one surface thereof such that said removable template member can be easily detached from said second layer second surface.

20. The decorative applique, as claimed in claim 13, said first layer and said third layer are transparent.
